(19) United States
(12) Patent Application Publication
(10) Pub. No.: US 2009/0109469 A1
(43) Pub. Date: Apr. 30, 2009

(54) OFFICE MACHINE AND FAX RECEIVING MODE SWITCH METHOD THEREOF

(75) Inventor: Chang-min HAN, Ansan-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/203,217

(22) Filed: Sep. 3, 2008

(30) Foreign Application Priority Data
Oct. 26, 2007 (KR) 2007-108486

(51) Int. Cl. G06F 3/12

(52) U.S. Cl. 358/1.15

(57) ABSTRACT

A fax receiving mode switch method of an office machine connecting with at least one host device, via a network and communicating with an external fax machine, is provided with: requesting a response to the at least one host device; and switching a mode of the office machine based on whether there is any response from the at least one host device.

### CROSS-REFERENCE TO RELATED APPLICATION

This application claims all benefits accruing under 35 U.S.C. §119 from Korean Patent Application No. 2007-108486, filed on Oct. 26, 2007 in the Korean Intellectual Property Office, the disclosure of which is incorporated herein by reference.

### BACKGROUND OF THE INVENTION

1. Field of the Invention

Aspects of the present invention relate to an office machine, and more particularly, to an office machine connected to one or more host devices, via a network, and a fax receiving mode switch method thereof.

2. Description of the Related Art

Office machines include an image forming apparatus forming an image corresponding to printing data on a recording medium, a scanner having a scanning function, a facsimile having a telephone function and a fax transmitting/receiving function, and the like. At a user's request, a multifunction peripheral (MFP) or the like, which is provided as a single device capable of performing above various functions, has recently been used as the office machines.

Such an office machine is typically connected to one or more host devices, directly or indirectly, via a network, and has a telephone mode for serving as a telephone and a fax receiving mode for serving as a facsimile to receive a document. However, if a user is absent from the office machine and the office machine is in a telephone mode, such an office machine is not capable of receiving a fax. As a result, the telephone mode has to be manually and inconveniently switched to the fax receiving mode in order for the office machine to receive such a fax when the user is absent from the office machine.

Meanwhile, there is an auto receiving mode which can be implemented into the office machine in which the telephone mode is automatically switched to the fax receiving mode in the absence of a user. However, a fee is charged because a telephone line is employed even in the auto receiving mode.

### SUMMARY OF THE INVENTION

Several aspects and example embodiments of the present invention provide an office machine which requests a response from a host device, via a network, and automatically switches a receiving mode to a fax receiving mode if there is no response from the host device, via the network, and a fax receiving mode switch method thereof for a user's convenience.

Another aspect of the present invention is to provide an office machine which is automatically switched from a fax receiving mode to a telephone receiving mode if there is no response from a host device, and a fax receiving mode switch method thereof for a user's convenience.

Still another aspect of the present invention is to provide an office machine capable of easily selecting a host device, which is required to make a response, through an Internet Protocol (IP) address table, and a fax receiving mode switch method thereof.

Additional aspects and/or advantages of the invention will be set forth in part in the description which follows and, in part, will be obvious from the description, or may be learned by practice of the invention.

In accordance with an example embodiment of the present invention, there is provided a fax receiving mode switch method of an office machine connecting with at least one host device, via a network and communicating with an external fax machine. Such a method comprises: requesting a response to the at least one host device; and switching a mode of the office machine based on whether there is any response from the at least one host device.

According to an aspect of the present invention, the request of the response may comprise using Internet Protocol (IP) address of the at least one host device.

According to another aspect of the present invention, the switch of the mode may comprise switching between a fax receiving mode for receiving a fax from the external fax machine and a telephone mode. the mode of the office machine is maintained if there is the response from the at least one host device, and is switched to the fax receiving mode if there is no response from the at least one host device.

According to another aspect of the present invention, the fax receiving mode switch method may further comprise setting a minimum number of host devices, which are required to make the response, among the at least one host device to switch the mode from a telephone mode to a fax receiving mode.

According to an aspect of the present invention, the request of the response may comprise periodically requesting the response.

According to another aspect of the present invention, the fax receiving mode switch method may further comprise displaying a switched mode if the mode is switched.

According to another aspect of the present invention, the request of the response may comprise selecting the host device which is required to make the response among the at least one host device.

According to another aspect of the present invention, the office machine may store the IP addresses of the at least one host device.

In accordance with another example embodiment of the present invention, an office machine is provided with a first communicating unit which communicates with an external fax machine; a second communicating unit which communicates with at least one host device, via a network; and a controller which requests a response to the at least one host device, and which controls the first communicating unit to switch to a mode of the office machine based on whether there is any response from the at least one host device.

According to an aspect of the present invention, the controller may use an Internet Protocol (IP) address of the at least one host device in requesting the response.

According to another aspect of the present invention, the controller may allow the mode to be switched between the fax receiving mode for receiving a fax from the external fax machine and a telephone mode.

According to another aspect of the present invention, the controller may maintain the mode if there is the response from the at least one host device and switches the mode if there is no response from the at least one host device.

According to yet another aspect of the present invention, the controller may set a minimum number of host devices, which are required to make the response, among the at least one host device to switch the mode.

According to an aspect of the present invention, the controller may periodically request the response, may display a switched mode when the mode is switched, and may select the host device which is required to make the response among the at least one host device.

According to another aspect of the present invention, the office machine may further comprise a storage unit to store the IP address of the at least one host device.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an office machine according to an example embodiment of the present invention;

FIG. 2 is a block diagram of an office machine according to another example embodiment of the present invention;

FIG. 3 shows a user interface for the office machine shown in FIG. 2;

FIG. 4 is a flowchart for explaining a fax receiving mode shift method of the office machine according to an example embodiment of the present invention; and

FIGS. 5 and 6 are flowcharts for explaining a fax receiving mode shift method of an office machine according to another example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

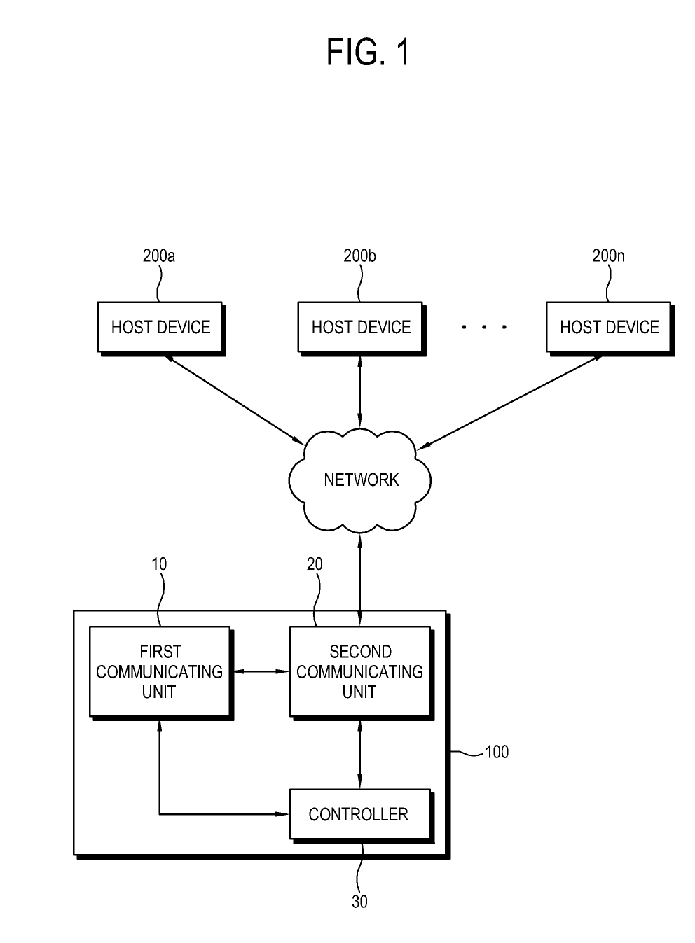

FIG. 1 is a block diagram of an office machine according to an example embodiment of the present invention. As shown in FIG. 1, an office machine 100 includes a first communicating unit 10, a second communicating unit 20, and a controller 30. The office machine 100 is connected to at least one of host devices 200a, 200b . . . 200n, via a network. For example, a facsimile of transmitting and receiving a fax, or a multi function peripheral (MFP) having a function of transmitting and receiving a fax may be employed as the office machine 100. Host devices 200a, 200b . . . 200n can be a computer system or workstation connected to the network.

The first communicating unit 10 transmits a fax to or receives a fax from an external fax machine. According to an example embodiment of the present invention, the first communicating unit 10 is controlled by the controller 30 to alter between a telephone mode for a telephone function and a fax receiving mode for a fax function, and is provided with a network card for transmitting and receiving a fax.

The second communicating unit 20 communicates with a host device 200, via a network, such as a public switched telephone network (PSTN) and a local area network (LAN).

The controller 30 requests a response from the host device 200, via the second communicating unit 20, while the first communicating unit 10 is in the telephone mode, and controls the first communicating unit 10 to switch from the telephone mode to the fax receiving mode if the host device 200 makes no response. In this example embodiment, the controller 30 transmits an Internet Controller Message Protocol (ICMP) echo request packet of a Packet Internet Groper (PING) test to the host device 200, thereby requesting a response from the host device 200.

The PING test verifies whether Internet protocol (IP) datagram arrives at another host device 200a, 200b . . . 200n, using a Transmission Control Protocol (TCP)/IP. In the PING test, an ICMP echo request message is transmitted to the host device 200 and the office machine 100 waits for a response. At this time, if the host device 200 is operating, the host device 200 receives the ICMP echo request message and transmits an ICMP echo reply packet. On the other hand, if the host device 200 is not operating, there is no transmission of the ICMP echo replay packet.

In the case that the controller 30 of the office machine 100 does not receive any response from at least one host device 200, via the network, the controller 30 controls the first communicating unit 10 to switch a receiving mode from the telephone mode to the fax receiving mode.

Here, the controller 30 requests the response from the host device 200 at intervals of a preset time, such as, minute, hour and the like, thereby precisely checking a state of the host device 200.

In the case that the first communicating unit 10 is switched to the fax receiving mode, the controller 30 requests the response again from the host device 200 and controls the first communicating unit 10 to return to the telephone mode when receiving the response, thereby enhancing convenience for a user.

Further, the controller 30 may control the first communicating unit 10 to maintain a current receiving mode when the response is made from at least one host device 200.

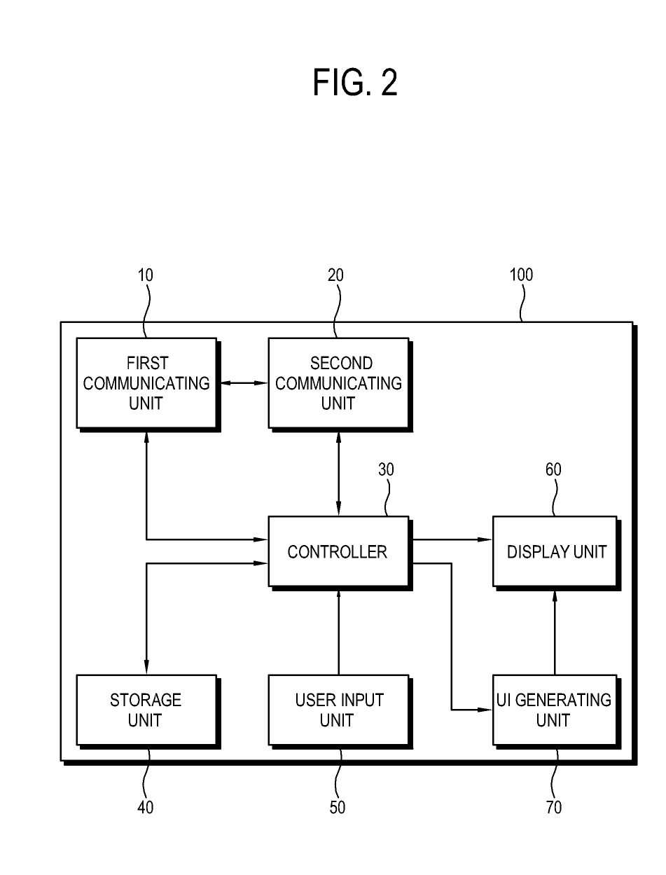

Turning now to FIG. 2, an office machine 100 according to another example embodiment of the present invention is shown. Such an office machine 100 includes a first communicating unit 10, a second communicating unit 20, and a controller 30, as shown in FIG. 1. However, unlike FIG. 1, such an office machine 100 further includes a storage unit 40, a user input unit 50, a display unit 60, and a user interface (UI) generating unit 70.

The storage unit 40 stores a table of IP addresses associated with the host devices 200a, 200b . . . 200n. In this example embodiment, the storage unit 40 may include not only a flash memory but also a non-volatile memory, such as a hard disk, or the like

The controller 30 requests a response from the host devices 200 corresponding to the IP addresses stored in the storage unit 30, and controls the storage unit 40 to edit the IP addresses stored therein. Further, the controller 30 may set a minimum number of host devices 200, which are required to make the response, among the host devices 200a, 200b . . . 200n corresponding to the stored IP addresses. Thus, the controller 30 requests the response from only the host device 200, which is required to make the response, among one or more host devices 200a, 200b . . . 200n.

The user input unit 50 allows a user to switch the receiving mode from the telephone mode to the fax receiving mode. Thus, according to a user's instructions, the telephone mode can be automatically switched to the fax receiving mode. Further, the user input unit 50 allows a user to add, modify and delete one or more IP addresses stored in the storage unit 40.

The display unit 60 shows the user a list of IP addresses stored in the storage unit 40. According to an example embodiment of the present invention, the display unit 60 displays the IP addresses through a user interface (UI) generated by the UI generating unit 70. For example, the display unit 60 may be realized as a liquid crystal display (LCD) provided at one side of the office machine 100.

The UI generating unit 70 generates a user interface (UI) which allows the user to edit the IP address stored in the storage unit 40. Further, the UI generating unit 70 may generate a UI which illustrates a status of the office machine 100, i.e., a switched receiving mode when the fax receiving mode is switched.

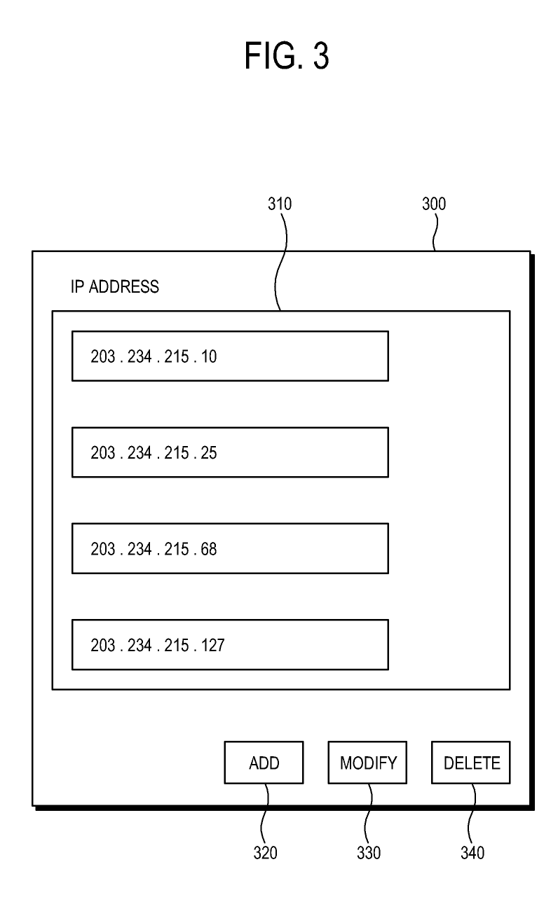

FIG. 3 shows an example user interface (UI) 300 which allows a user to edit the IP address of the host device 200 in the office machine 100 shown in FIG. 2. As shown in FIG. 3, the UI generating unit 70 is controlled by the controller 30 and generates a user interface (UI) 300 for showing a list 310 of IP addresses of the host devices 200a, 200b . . . 200n connected to the office machine 100, and control buttons, such as “add,” 320, “modify,” 330, and “delete” 340 for editing the IP addresses.

When a user selects the “add”” button 320 for adding the host device 200, a new window is opened for allowing a user to input an IP address of a new host device. When the IP address is additionally input, the controller 30 controls the storage unit 40 to store the additional IP address. Meanwhile, if a user selects the “modify” button 330 or the “delete” button 340 when a certain IP address is selected among the IP addresses displayed on the display unit 60, the controller 30 may control the storage unit 40 to modify or delete the IP address as the user desires.

Thus, the office machine 100 according to an example embodiment of the present invention advantageously allows a user to easily select one or more host devices 200a, 200b . . . 200n, which are required to make a response, among the host devices 200a, 200b . . . 200n connected to the office machine 100.

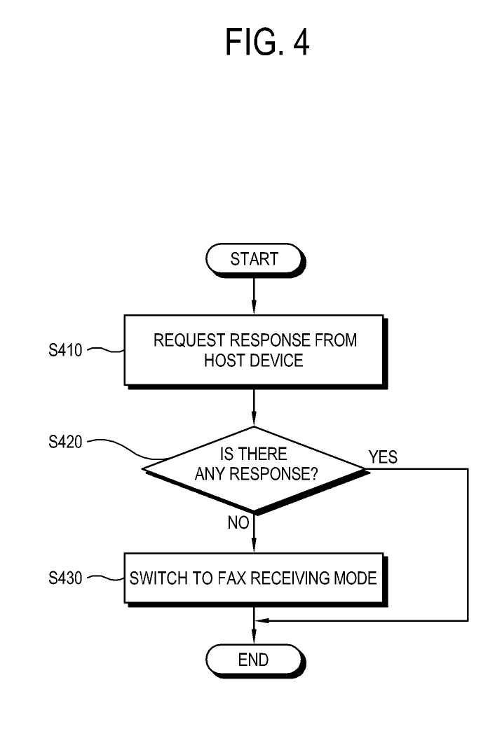

Below, a fax receiving mode switch method of the office machine 100 according to an example embodiment of the present invention will be described with reference to FIG. 4.

First, at operation S410, the controller 30 requests a response from the host device 200, while the first communicating unit 100 is in the telephone mode. At operation S420, the controller 200 determines whether a response is received from the host device 200. If there is no response from the host device 200, the controller 30 controls the first communicating unit 10 to switch from the telephone mode to the fax receiving mode at operation S430. Here, the operation S430 may include a process of displaying the switched receiving mode.

At operation S410, the controller 30 may periodically request the response from the host device 200, thereby more precisely checking the state of the host device 200.

At operation S430, the controller 30 may also request the response again from the host device 200 after switching the telephone mode to the fax receiving mode, and return to the telephone mode when receiving the response from the host device 200. Further, the controller 30 may maintain the current receiving mode when receiving the response from at least one host device 200, for user's convenience.

Also, at operation S410, the controller 30 may select the host device 200, which are required to make the response, among one or more host devices 200a, 200b . . . 200n, via the network, and may set a minimum number of host devices 200 which are require to make the response. Here, the controller 30 may store and edit the IP address of at least one host device 200.

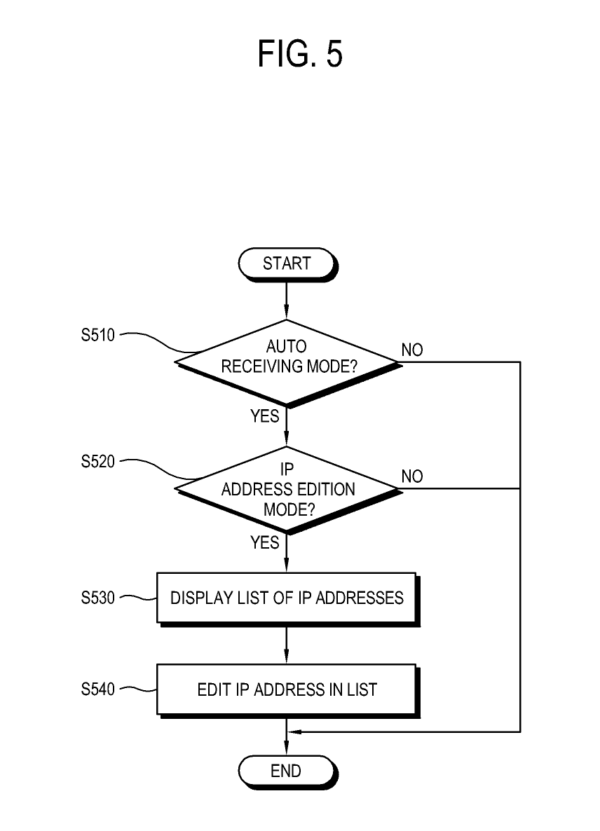

Below, a communicating method of an office machine 100 according to an example embodiment of the present invention will be described with reference to FIG. 5.

First, at operation S510, the controller 30 determines whether the office machine 100 is in an auto receiving mode for switching to the fax receiving mode. When the office machine 100 is in the auto receiving mode, the controller 30 determines whether the auto receiving mode is in an IP address edition mode for editing the IP address at operation S520. In case of the IP address edition mode, a list of the IP addresses is displayed on the user interface (UI) 300, shown in FIG. 3, at operation S530, such that the IP addresses can be edited at operation S540. Accordingly, the host device 200 which is required to make response can be easily selected.

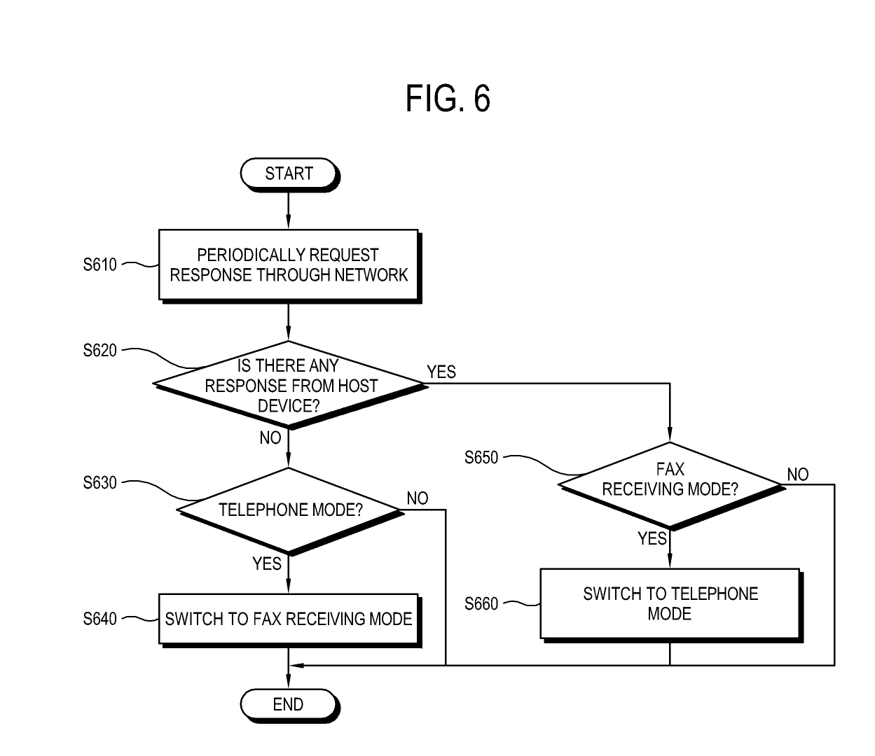

FIG. 6 is a flowchart of a communicating method of an office machine 100 according to another example embodiment of the present invention. At operation S610, the controller 30 periodically requests a response from the host device 200, via a network. At operation S620, the controller 30 determines whether there is a response from the host device 200. If there is no response from the host device 200, the controller 30 determines again whether the receiving mode is the telephone mode at operation S630. If the receiving mode is the telephone mode, the controller 30 controls the first communicating unit 10 to switch from the telephone mode to the fax receiving mode.

If there is a response from the host device 200 at the operation S620, the controller 30 determines again whether the receiving mode is the fax receiving mode at operation S650. If the receiving mode is the fax receiving mode, the controller 30 controls the first communicating unit 10 to switch from the fax receiving mode to the telephone mode at operation S660.

As described above, example embodiments of the present invention advantageously provide an office machine, which requests a response from a host device and automatically switches a receiving mode to a fax receiving mode if the host device makes no response, and a fax receiving mode switch method thereof, thereby consulting a user's convenience.

In addition, the present invention provides an office machine which is automatically switched from a fax receiving mode to a telephone receiving mode if a host device makes a response, and a fax receiving mode switch method thereof, thereby consulting a user's convenience. Moreover, the present invention provides an office machine capable of easily selecting a host device, which is required to make a response, through an IP address table, and a fax receiving mode switch method thereof.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A fax receiving mode switch method of an office machine connecting with at least one host device, via a network, and communicating with an external fax machine, the method comprising:
requesting a response to the at least one host device; and
switching a mode of the office machine based on whether there is any response from the at least one host device.

2. The fax receiving mode switch method according to claim 1, wherein the request of the response comprises using Internet Protocol (IP) address of the at least one host device.

3. The fax receiving mode switch method according to claim 1, wherein the switch of the mode comprises switching between a fax receiving mode for receiving a fax from the external fax machine and a telephone mode.

4. The fax receiving mode switch method according to claim 3, wherein the mode of the office machine is maintained if there is the response from the at least one host device, and is switched to the fax receiving mode if there is no response from the at least one host device.

5. The fax receiving mode switch method according to claim 1, further comprising setting a minimum number of host devices, which are required to make the response, among the at least one host device to switch the mode from a telephone mode to a fax receiving mode.

6. The fax receiving mode switch method according to claim 1, wherein the request of the response comprises periodically requesting the response.

7. The fax receiving mode switch method according to claim 1, further comprising providing a visual display of a switched mode if the mode is switched.

8. The fax receiving mode switch method according to claim 1, wherein the request of the response comprises selecting the host device which is required to make the response among the at least one host device.

9. The fax receiving mode switch method according to claim 2, wherein the office machine stores the IP addresses of the at least one host device.

10. An office machine comprising:
a first communicating unit which communicates with an external fax machine;
a second communicating unit which communicates with at least one host device, via a network; and
a controller which requests a response to the at least one host device, and which controls the first communicating unit to switch to a mode of the office machine based on whether there is any response from the at least one host device.

11. The office machine according to claim 10, wherein the controller uses an Internet Protocol (IP) address of the at least one host device in requesting the response.

12. The office machine according to claim 10, wherein the controller controls the first communicating unit to switch the mode between a fax receiving mode for receiving a fax from the external fax machine and a telephone mode.

13. The office machine according to claim 12, wherein the controller maintains the mode if there is the response from the at least one host device and switches the mode if there is no response from the at least one host device.

14. The office machine according to claim 10, wherein the controller sets a minimum number of host devices, which are required to make the response, among the at least one host device to switch the mode.

15. The office machine according to claim 10, wherein the controller periodically requests the response from the at least one host device.

16. The office machine according to claim 10, further comprising a display unit to provide a visual display of a switched mode when the mode is switched.

17. The office machine according to claim 10, wherein the controller selects the host device which is required to make the response among the at least one host device.

18. The office machine according to claim 11, further comprising a storage unit to store the IP address of the at least one host device.

19. An office machine comprising:
a first communicating unit to communicate with an external fax machine;
a second communicating unit to communicate with one or more host devices, via a network; and
a controller arranged to control the second communicating unit to periodically request a response from one or more host devices, and to control the first communicating unit to switch between a telephone mode and a fax receiving mode, based on whether there is any response from one or more host devices.

20. The office machine according to claim 19, wherein, when there is a response received from a host device, the controller determines if the first communicating unit is in the fax receiving mode and, if the first communicating unit is in the fax receiving mode, controls the first communicating unit to switch to the telephone mode.

21. The office machine according to claim 19, wherein, when there is no response received from a host device, the controller determines if the first communicating unit is in the telephone mode and, if the first communicating unit is in the telephone mode, controls the first communicating unit to switch to the fax receiving mode.

22. The office machine according to claim 19, wherein the controller is further configured to set the first communicating unit in an auto receiving mode for automatically switching to the fax receiving mode, and provide a visual display of a list of Internet Protocol (IP) addresses of the one or more host devices for selection.

23. The office machine according to claim 19, wherein the controller maintains the receiving mode when receiving a response from the at least one host device.

24. The office machine according to claim 19, wherein the controller is further configured to set a minimum number of host devices, which are required to make the response, among the one or more host devices.

25. The office machine according to claim 19, further comprising:
a storage unit to store a list of Internet Protocol (IP) addresses of the one or more host devices available; and
a display unit to provide a visual display of the list of Internet Protocol (IP) addresses of the one or more host devices for selection, and provide a visual display of a switched receiving mode when the receiving mode is switched between the telephone mode and the fax receiving mode.
